(19) United States
(12) Patent Application Publication
(10) Pub. No.: US 2010/0262607 A1
(43) Pub. Date: Oct. 14, 2010

(54) System and Method for Automatic Matching of Contracts to Impression Opportunities Using Complex Predicates and an Inverted Index

(76) Inventors: Sergei Vassilvitskii, New York, NY (US); Ramana Yerneni, Cupertino, CA (US); Jayavel Shanmugasundaram, Santa Clara, CA (US); Erik Vee, San Mateo, CA (US); Chad Brower, San Jose, CA (US); Steven Whang, Stanford, CA (US)

Correspondence Address: STATTLER - SUH PC, 60 SOUTH MARKET STREET, SUITE 480, SAN JOSE, CA, 95113, US

(21) Appl. No.: 12/421,974

(22) Filed: Apr. 10, 2009

(51) Int. Cl. G06F 17/30; G06Q 30/00

(52) U.S. Cl. 707/742; 707/E17.014; 707/E17.044

(57) ABSTRACT

A method for indexing advertising contracts for rapid retrieval and matching in order to match satisfying contracts to advertising slots. The descriptions of the advertising contracts include logical predicates indicating applicability to a particular demographic. Also, the descriptions of advertising slots contain logical predicates indicating applicability to a particular demographic, thus matches can be performed using at least matches on the basis of intersecting demographics. The disclosure contains structure and techniques for receiving a set of contracts with predicates, preparing a data structure index of the set of contracts, receiving an advertising slot with predicates, and structure and techniques for retrieving from the data structure contracts that satisfy a match to the advertising slot predicates. The disclosure includes cases were the predicates are presented in conjoint forms and in disjoint forms, and techniques are provided to consider indexing and matching in cases of IN predicates and well as NOT-IN predicates.

### FIELD OF THE INVENTION

The present invention is directed towards management of on-line advertising contracts based on targeting.

### BACKGROUND OF THE INVENTION

The marketing of products and services online over the Internet through advertisements is big business. Advertising over the Internet seeks to reach individuals within a target set having very specific demographics (e.g. male, age 40-48, graduate of Stanford, living in California or New York, etc). This targeting of very specific demographics is in significant contrast to print and television advertisement that is generally capable only to reach an audience within some broad, general demographics (e.g. living in the vicinity of Los Angeles, or living in the vicinity of New York City, etc.). The single appearance of an advertisement on a webpage is known as an online advertisement impression. Each time a web page is requested by a user via the Internet, represents an impression opportunity to display an advertisement in some portion of the web page to the individual Internet user. Often, there may be significant competition among advertisers for a particular impression opportunity to be the one to provide that advertisement impression to the individual Internet user.

To participate in this competition, some advertisers enter into contracts with an ad serving company (or publisher) to receive impressions over a desired time period. An advertiser may further specify desired targeting criteria. For example, an advertiser and the ad serving company may agree to post 2,000,000 impressions over thirty days for US$15,000. Others merely enter into non-guaranteed contracts with the ad server company and only pay for those impressions actually made by the ad serving company on their behalf. Of course, in modern Internet advertising systems, the competition among advertisers is often resolved by an auction, and the winning bidder's advertisements are shown in the available spaces of the impression.

Indeed online advertising and marketing campaigns often rely at least partially on an auction process where any number of advertisers book contracts to submit and authorize highest bids corresponding to the contract characteristics (e.g. keywords, or bid phrases or various demographics). The advertisements corresponding to the winning contracts are used for presenting the impression.

Considering that (1) the actual existence of a web page impression opportunity suited for displaying an advertisement is not known until the user clicks on a link pointing to the subject web page, and (2) that the bidding process for selecting advertisements must complete before the web page is actually displayed, it then becomes clear that the process of assembling competing contracts, completing the bidding, and compositing the web page with the winner's ads must start and complete within a matter of fractions of a second. Thus, a system that rapidly matches contracts to opportunities for the purpose of optimizing the allocation of online advertising is needed.

Other automated features and advantages of the present invention will be apparent from the accompanying drawings, and from the detailed description that follows below.

### SUMMARY OF THE INVENTION

A method for indexing online advertising contracts for rapid retrieval and matching in order to match satisfying online advertising contracts to online advertising slots. The descriptions of the advertising contracts include logical predicates indicating applicability to a particular demographic or targeted web page viewer as defined by the advertiser. Also, the descriptions of advertising slots contain logical predicates indicating demographics or targets of a particular web page and/or web page viewer, thus matches can be performed using at least matches on the basis of intersecting demographics or other sets of target descriptors. Included are structure and techniques for receiving a set of contracts with predicates, preparing a data structure index of the set of contracts, receiving an advertising slot with predicates, and further includes structure and techniques for retrieving from the data structure a set of contracts that satisfy one or more match criteria to match the advertising slot predicates. Embodiments include cases were the predicates are presented in conjoint forms and in disjoint forms, and techniques are provided to consider indexing and matching in cases of IN predicates and well as NOT-IN predicates.

### BRIEF DESCRIPTION OF THE DRAWINGS

The novel features of the invention are set forth in the appended claims. However, for purpose of explanation, several embodiments of the invention are set forth in the following figures.

FIG. 1A shows an ad network environment in which some embodiments operate.

FIG. 1B shows an ad network environment including an auction engine server in which some embodiments operate.

FIG. 2A is a depiction of a two-dimensional table of inventory, according to according to one embodiment.

FIG. 2B is a depiction of a three-dimensional table of inventory, according to according to one embodiment.

FIG. 3 is a depiction of a system for serving advertisements within which some embodiments may be practiced.

FIG. 4 is a depiction of a modularized environment including delivering a set of contracts within which some embodiments may be practiced.

FIG. 5 is a depiction of a modularized environment including constructing an inverted index within which some embodiments may be practiced.

FIG. 6 is a diagrammatic representation of a machine in the exemplary form of a computer system, within which a set of instructions may be executed, according to according to one embodiment.

FIG. 7 is a diagrammatic representation of several computer systems in the exemplary environment of a client server network, within which environment a communication protocol may be executed, according to one embodiment.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order to not to obscure the description of the invention with unnecessary detail.

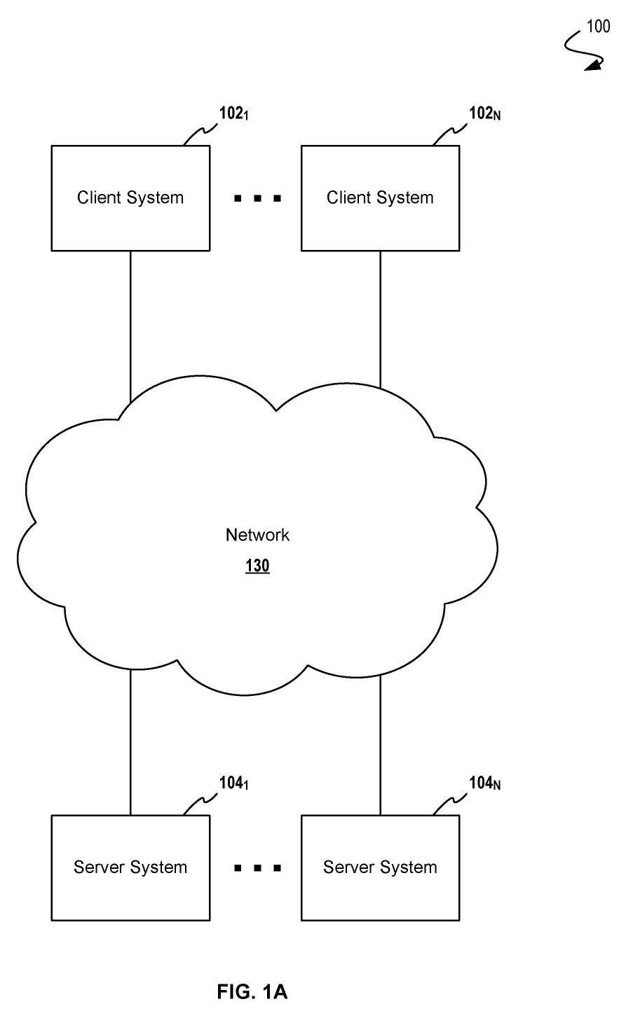

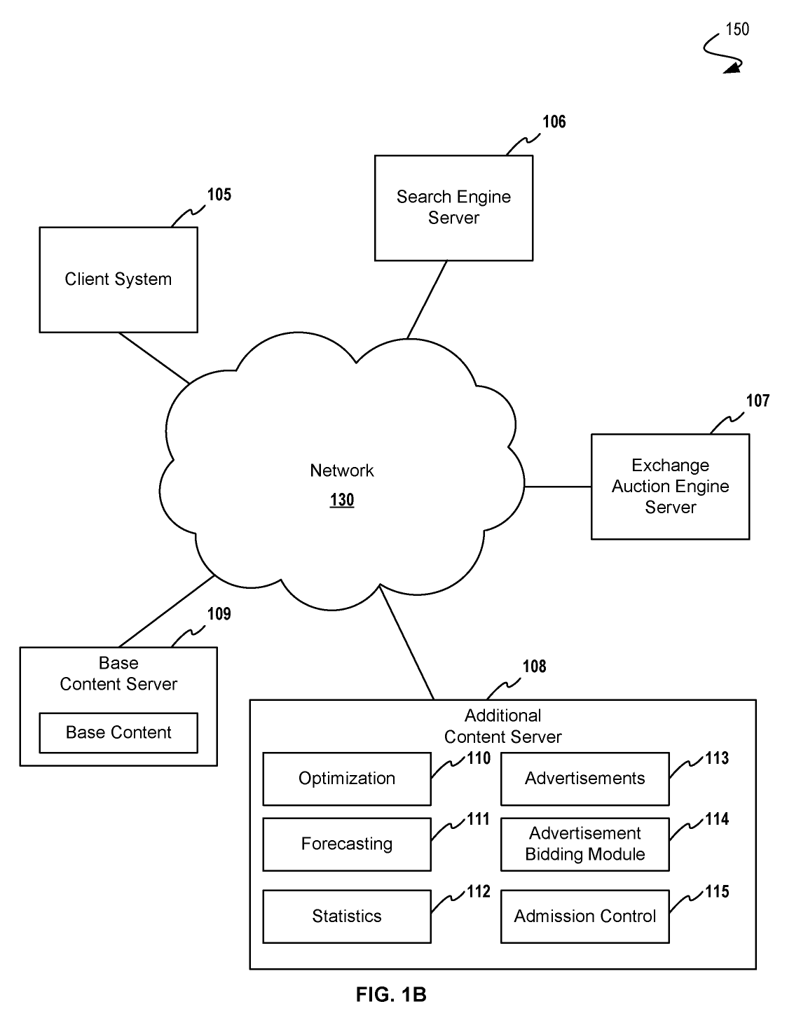

In the context of Internet advertising, bidding for placement of advertisements within an Internet environment (e.g. system 100 of FIG. 1A) has become common. By way of a simplified description, an Internet Advertiser may select a particular property (e.g. the landing page for the Empire State, empirestate.com), and may create an advertisement such that whenever any Internet user, via a client system 102₁-102_{N} renders the web page from empirestate.com, the advertisement is composited on a web page by a server 104₁-104_{N} for delivery to a client system 102 over a network 130. This model works well for property-oriented advertising: The number of visits to such property's web pages (i.e. number of hits in a time period) is easy to capture over time, and thus, a history of visits is a good estimate of the number of visits one could expect in the near future, and thus a recent history of web page visits is a good predictor of some future number of hits. This is analogous to print media in that an advertiser noting that the previous month had a readership of 10,000 would reasonably expect roughly 10,000 readers in the following month. Neither of these models, as described, takes into account any specific demographics.

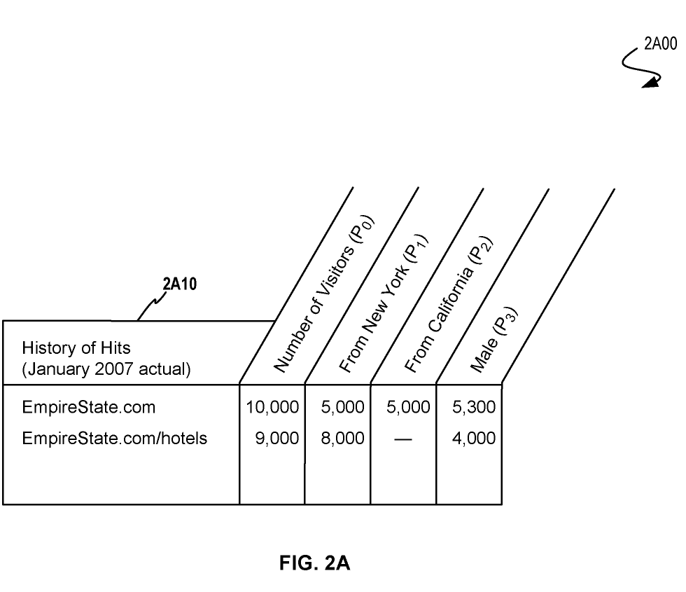

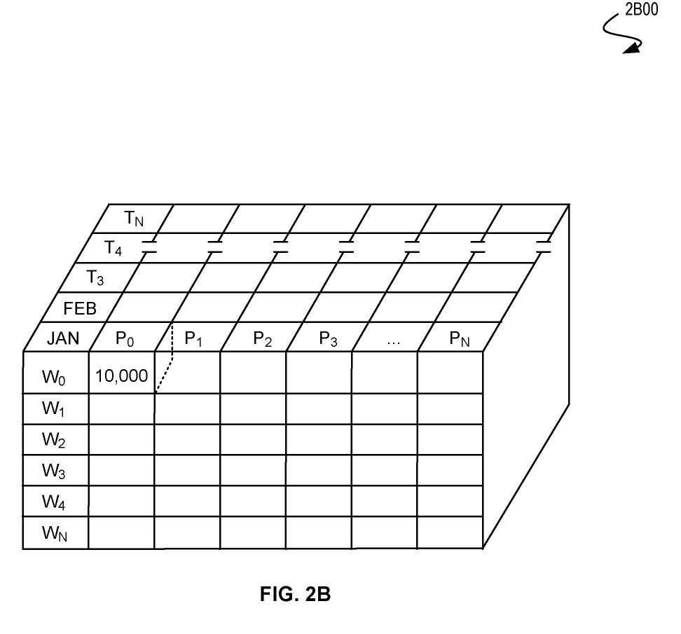

In the slightly more sophisticated model of FIG. 1B, referring to system 150, and considering only Internet advertising, an Internet property (e.g. empirestate.com) hosted on a content server 109, might measure 10,000 hits in a given month. It also might be able to measure that of those 10,000 hits, 5000 of those hits originated from client systems 105 located in California. It might further be able to measure that of the 10,000 hits from California, 5300 of those were from individuals who identified themselves as male. Still further, the Internet property might be able to measure the number of visitor to empirestate.com who traversed to a sub-page, say empirestate.com/hotels or the Internet property might be able to measure the number of visitors that arrived at the empirestate.com domain based on a referral from a search engine server 106. Still further, an Internet property might be able to measure the number of visitors that have any arbitrary characteristic, demographic or attribute, possibly using an additional content server 108, in conjunction with a data gathering or statistics operation 112. Thus, an Internet user might be ‘known’ in quite some detail as pertains to a wide range of demographics or other attributes. As shown in FIG. 2A, a table of inventory 2A10 can be constructed showing a variety of demographics. For example, a history of hits and other analytics (i.e. actual hits as measured) might indicate how many hits occurred in a particular month (e.g. January 2007) at a particular page (e.g. empirestate.com had 10,000 visitors) or sub-page (e.g. empirestate.com/hotels had 9,000 visitors). And to the extent that any particular demographics can be captured (e.g. visitors from New York, visitors from California, male visitors, etc) those counts might also be captured and used in predicting inventory for an upcoming time period. As shown, FIG. 2A depicts page hits for just one month (e.g. January, 2007), however any number of time periods might be represented in a three dimensional table.

FIG. 2B depicts a three dimensional table 2B00 showing dimensions of web site page (e.g. W₀, W₁, W₂, Wₙ), time period (e.g. T₀, T₁, T₂, Tₙ), and some selection of demographic properties (e.g. P₀, P₁, P₂, Pₙ). As shown, there were 10,000 hits in January at web page W₀ corresponding to the property P₀. In the context of demographics available for various populations, FIG. 2B is a trivial example in only three dimensions. Typically, many more dimensions are available, and might be represented in an N-space array (i.e. high-dimensional space). Of course any N-dimensional array where N is greater than three is difficult to show on paper. However alternative representations such as an N-dimensional array (where N is any positive integer) and methods for identifying sets of points (e.g. showing conjoint or disjoint, or overlapping sets), or lists of attribute/value pairs (e.g. {state, California}, {gender, male}, {age, 45}, {weight, 165}) might be used to represent points in N-dimensional space.

Given any of such representations of a point in N-dimensional space, any degree of N can be captured over time, and such a capture (e.g. a history) might be used in predicting future events. A finer degree of specificity is useful in targeted advertising. For example, an advertiser for a hotel in mid-town New York City might want to place advertisements only on the empirestate.com/hotels web page as shown to an Internet user, and then only if the Internet user is from California, and then only if the Internet user is male, and so on. Such an advertiser might be willing to pay a premium for a spot that is most prominently located on the web page. In fact, such an advertiser might be joined by other hoteliers who also want their advertisements to be displayed in the most prominently located spot on the web page. However, the inventory for that one web page impression being displayed to that particular user at that point in time is of course limited to just that one impression. Thus, multiple competing advertisers might elect to bid in a market (e.g. an exchange) via an exchange server or auction engine 107 in order to win the most prominent spot, or an advertiser might enter into a contract (e.g. with the Internet property or with an advertising agency, or with an advertising network, etc) to purchase in advance all of the desired spots for some time duration (e.g. all top spots in all impressions of the web page empirestate.com/hotels for all of 2008). Such an arrangement and variants as used here is termed a contract. A contract might be as simple as the one in the previous example, or a contract might be more complex, possibly involving many attribute, value pairs to describe a target. Alternatively, the advertiser might not enter into such a pre-arranged placement contract (also known as guaranteed delivery), and instead might decide to allow impressions to be made over time, on the fly, when the advertiser's bid is the winning bid (also known as non-guaranteed delivery). In some embodiments, the system 150 might host a variety of modules to serve management and control operations (e.g. forecasting 111, admission control 115, automated bidding management 114, objective optimization 110, etc) and storage functions (e.g. storage of advertisements 113, storage of statistics 112, etc) pertinent to both guaranteed delivery as well as non-guaranteed delivery methods. Of course there are many differences and many implications in the set-up and operation of guaranteed delivery versus non-guaranteed delivery, some of which are described below.

### Section I: General Terms and Network Environment

In most cases, the set-up and operational differences between guaranteed delivery model versus non-guaranteed delivery model creates artificial distinctions between these two models. In particular, pricing of display inventory that is priced at fixed contract prices (e.g. guaranteed delivery contracts), and pricing of inventory that is priced in a real-time auction in a spot market or through other means (non-guaranteed delivery) may differ significantly. In some cases the fixed contract price of an impression is lower than the true market value of the impression (e.g. if the fixed price contract covered some exceptionally high traffic period). In some cases, the reverse is true. Additional artificial distinctions between these two models cause difficult-to-price differences, for instance, some ad network systems always serve guaranteed contracts their quota before serving non-guaranteed contracts. This mode can result in the phenomenon of high-quality impressions to be mostly served to guaranteed contracts.

In some markets, however, advertisers demand a mix of guaranteed and non-guaranteed contracts. This creates a need for a unified marketplace whereby an impression opportunity can be allocated to a guaranteed or non-guaranteed contract based on the value of the impression opportunity to the different contracts. Such a unified marketplace enables a more equitable allocation of inventory, and also promotes increased competition between guaranteed and non-guaranteed contracts.

What is needed are techniques that enables guaranteed contracts to bid on the spot-market for each impression opportunity and thus compete directly with non-guaranteed contracts. The need is intensified the more that display advertising increases in refinement of the target. Indeed increased targeting allows advertisers to reach more relevant customers. For example, an advertiser selling family fitness aids might specify a target using broad targeting constraints such as “1 million Yahoo! users from 1 Aug. 2008-31 Aug. 2008”. In contrast, an advertiser selling fitness aids for surfers might specify a much more fine-grained constraint such as “10,000 Yahoo! users from 1 Aug. 2008-8 Aug. 2008 who are California males between the ages of 20-35 who are working in the healthcare industry and like surfing and autos”. Fine-grained targeting has implications to the aforementioned techniques. First, there is the need to forecast future inventory for fine-grained targeted combinations. Second, there is the need to manage contention in a high-dimensional targeting space. That is, given hundreds (or thousands, or more) distinct targeting attributes it is reasonable that different advertisers might specify different high-dimensioned targets, and further that multiple advertisers might specify overlapping targeting combinations. Thus there is a need to accurately forecast inventory of targeted impression opportunities such that the union of all guaranteed contracts do not substantially over subscribe the available impression opportunities. Resolving to a statistically reliable forecast of inventory (e.g. a plan) might be supported in part by historical statistics and heuristics.

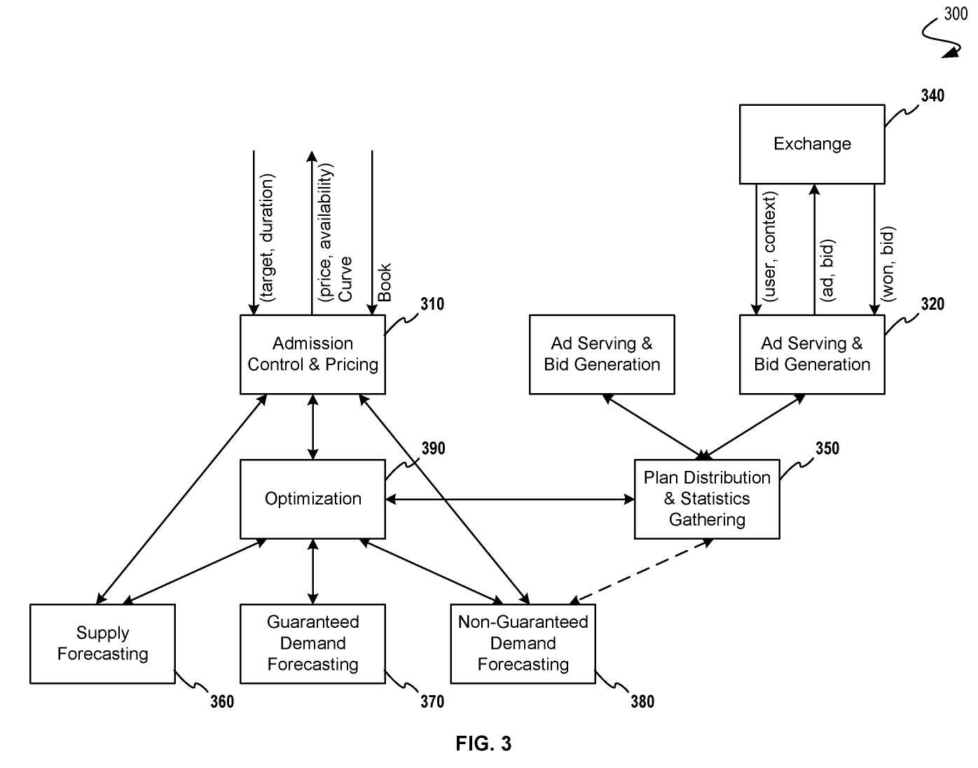

FIG. 3 depicts a system 300 in which embodiments of the invention might be practiced. As depicted, a system of components cooperatively communicate such that various overall objectives might be met. For example, an objective stated as “optimize guaranteed delivery revenue” might employ a module to coordinate the data exchange and execution of various system components, including (for example) an admission control module 310, an ad serving and bid generation module 320, an exchange module 340, a plan distribution module 350, a supply and forecasting module 360, a guaranteed demand forecasting module 370, a non-guaranteed demand forecasting module 390, and an optimization module 390.

Given such an environment the admission control portion of module 310 serves to generate quotes for guaranteed contracts and accept bookings of guaranteed contracts, the pricing portion of module 310 serves to price guaranteed contracts, the ad serving portion of module 320 selects guaranteed ads for an incoming opportunity, the bidding portion of module 320 submits bids for the selected guaranteed ads on an exchange 340 Additionally, an optimizer 390 might communicate with a plan distribution and statistics gathering module 350, and one or more forecasting modules 360, 370, 380 and return results that optimizes for an overall objective.

Given the system 300 of FIG. 3, a possible operational scenario might proceed as follows: The admission control module supports queries and other interactions with sales personnel who quote guaranteed contracts to advertisers, and book the resulting contracts. A sales person issues a query with a specified target (e.g., “100,000 Yahoo! users from 1 Aug. 2008-8 Aug. 2008 who are California males between the ages of 20-35 who are working in the healthcare industry and like surfing and autos”). The admission control module 310 returns the available inventory for the target and returns the associated price for the available inventory. The sales person can then book corresponding contracts accordingly. The ad server module 320 takes in an opportunity (e.g. an impression opportunity), and returns an ad corresponding to the opportunity along with the amount that the system is willing to bid for that opportunity in the spot market (the Exchange).

In one embodiment, the operation of the entire system 300 is orchestrated by an optimization module 390. This optimization module 390 periodically takes in a forecast of supply (future impression opportunities), guaranteed demand (expected guaranteed contracts) and non-guaranteed demand (expected bids in the spot market) and matches supply to demand using an overall objective function. The optimization module then sends a plan of the optimization result to the admission control and pricing module 310. Of course, inasmuch as the plan is based on statistics relating to data gathered over time, the plan is updated every few hours based on new estimates for supply, new estimates demand, and new estimates for deliverable impressions.

In another scenario, and one that relates to techniques for finding all applicable contracts (i.e. guaranteed as well as non-guaranteed contracts), and bringing their respective bids to the unified marketplace might operate in a scenario described as follows: When a sales person issues a query (to the admission control and pricing module 310) for some contract (e.g. including a target specification and duration) for future delivery (i.e. guaranteed or non-guaranteed), the system 300 invokes the supply forecasting module 360 to identify how much inventory is available for that contract. Since targeting queries can be very fine-grained in a high-dimensional space, the supply forecasting module might employ a scalable multi-dimensional database indexing technique to capture and store the correlations between different targeting attributes. The scalable multi-dimensional database indexing technique might also serve to capture and retrieve correlations found among multiple contracts. For example, if there are two sales persons submitting contracts in contention (e.g. “Yahoo! finance users who are California males” and “Yahoo! users who are aged 20-35 and interested in sports”), some number of forecasted impression opportunities might match both contracts, but of course the inventory of matching impression opportunities should not be double-counted. In order to deal with contract contention for supply in a high-dimensional space, the supply forecasting system might produce impression samples (i.e. a selected subset of the total available inventory) as opposed to just available inventory counts. Thus, impression opportunity samples from available inventory might be used to determine how many contracts can be satisfied by each impression opportunity. Given the impression samples, the admission control module uses the plan to calculate the extent of contention between contracts in the high-dimensional space. Finally, the admission control and pricing module 310 might return allocated available inventory to each of the sales persons without any double-counting. In addition, the admission control module might calculate the price for each contract and return pricing along with the quantity of allocated impression opportunities.

Now, stating the problem to be solved more formally, given an advertising opportunity (e.g. an impression opportunity), specified as a vector (e.g. list) of (feature, value) pairs, find all of the contracts that could bid on this opportunity. For example, given the conjunctive impression opportunity profile vector {(state=CA) AND (gender=male) AND (age=50)}, some possibly matching contracts would include those asking for {(gender=male) AND (state=CA)}, and would include those asking for {(gender=male) AND {(age=50)} because each clause of each of those contracts are satisfied against the example impression opportunity vector. The embodiments of the invention herein permits both disjunctive as well as conjunctive types of contracts and even contracts including more complex predicates to be handled efficiently. As regards contracts including complex predicates, embodiments of the invention disclosed herein support both “IN” (e.g. state IN (NY, CA, MA)) and “NOT-IN” predicates (e.g. state NOT-IN (NY, CA, MA)).

In various embodiments, a contract might be specified in some arbitrarily complex logic expression, which expression can be mathematically transformed into a disjunctive normal form (DNF) or into conjunctive normal form (CNF). A contract specified as a DNF expression contains any number “or” terms, any one of which, if satisfied satisfies the specification of the contract. A contract specified as a CNF expression contains any number of “and” conjunctions, such that all conjunctions must be satisfied in order to satisfy the specification of the contract. Once a contract has been normalized (i.e. into DNF or into CNF) each term can be considered a subcontract. To handle contracts in DNF (OR-ing), the techniques disclosed herein might split a contract into subcontracts (one for each term), and produce an index entry for each of the subcontracts. To support contracts in CNF (AND-ing), the techniques check to confirm that each of the subcontracts is found in the index.

### Section II: Detailed Description of the Problem Solved by an Efficient Inverted Index System

As indicated in the foregoing, one application served by the construction of an efficient inverted index system related to booking and satisfying online advertisement contracts. It should be emphasized that time between an Internet user's click on a link and the display of the corresponding page—including any advertisements is a short period, desirably a fraction of a second. It is within this short time period that applicable contracts must be identified, some or all of those contracts compete for spots on the soon-to-be-displayed webpage, the winner's or winners' advertisements are selected and placed in the webpage, and finally the webpage is rendered at the user's terminal. Thus, an efficient inverted index might be efficient as measured by latency, as well as efficient with respect to computing cycles, especially when many contracts may be booked at any given moment in time.

Further, the inverted index system may receive any arbitrarily complex expressions that describe a contract. The indexing techniques disclosed herein address at least solving the lookup problem efficiently and even under conditions where the input data is complex.

### Syntax and Construction of Contracts and Impression Opportunities

A contract is a DNF expression using IN and NOT-IN predicates as the most basic predicates. An impression opportunity is a point within a multi-dimensional space where any point can be described using finite domains for each attribute along a dimension.

### Section III: Syntax Used in Construction of Inverted Index

### Contract Syntax Using Basic Predicates

There are two types of basic predicates: IN predicates and NOT-IN predicates. For example, the predicate state IN {CA, NY} says that the state could either be CA or NY. The predicate state NOT-IN {CA, NY} indicates the state could be anything other than CA or NY. It is important to observe that state IN {CA, NY} is equivalent to state IN {CA} [symbol] state IN {NY} (making it a disjunction of length 2) while state NOT-IN {CA, NY} is equivalent to state NOT-IN {CA} [symbol] state NOT-IN {NY} (making it a conjunction of length 2). Notice that IN and NOT-IN predicates also cover equality and non-equality predicates. Other basic predicate types might also be supported, but are not required for construction of an inverted index. Using only IN and NOT-IN, for example, ranges of integers can be supported by converting them into equality predicates using hierarchical information of integer ranges.

### Contract Structure

A contract is a DNF or CNF expression on the two basic expressions IN and NOT-IN. For example, (state IN {CA, NY} [symbol] age IN {20}) [symbol] (state NOT-IN {CA, NY} [symbol] interest IN {sports}) is a DNF expression using the two types of atomic expressions while (state IN {CA, NY} [symbol] age IN {20}) [symbol] (interest IN {sports}) is a CNF expression. Notice that a conjunction can either be a DNF expression with one disjunct or a CNF expression with conjuncts of size 1.

### Impression Opportunity Profile

A profile of an impression opportunity is a set of attribute and value pairs. For example, {state=CA [symbol] age=20 [symbol] interest=sports} is a profile. An impression opportunity profile is a single point in a multi-dimensional space. Hence, each attribute within the set defining the impression opportunity profile has exactly one value.

### Section IV. Index Construction

Construction of an inverted index may commence by making posting lists of contracts for each IN predicate. For each attribute name and single value pair of an IN predicate, we make one posting list. Hence, the index structure “flattens” the IN predicates when constructing the posting lists. In the embodiments described herein, the inverted index is sorted. Furthermore, each posting list might sort its contracts by contract id, and the posting lists themselves might be sorted by the ids of their current contracts. Of course other ids or keys might be used for sorting the posting lists, and/or for sorting contracts within a posting list, and such alternative ids and keys are possible and envisioned. For example, contracts might be sorted by any arbitrary key, such as customer type.

Algorithm 1: Construct Inverted Index

1: input: set of contracts C
2: output: inverted index idx
3: idx.init( )
4: for all contract c 531 C do
5: for all atomic predicate p 531 c do
6: c’← c /*make copy of contract*/
7: if p.type = NOT-IN then
8: c’.flag ← NOT-IN
9: end if
10: for all value [symbol] 531 p.list do
11: idx.getList(p.attrname, v).add(c’) /*make sure to keep the
posting lists and the contracts within each posting list sorted*/
12: end for
13: end for
14: end for
15: return idx

Example: Consider the two contracts in Table 1. For each attribute name and possible value, Algorithm 1 constructs a posting list of contracts with flags. The final inverted index is shown in Table 2. Notice how all the IN predicates are flattened out into single values. Each posting list has its contracts sorted, and the posting lists themselves are also sorted according to the contracts they have.

TABLE 1
A set of contracts

| Contract | Expression |
|---|---|
| c₁ | age IN {1, 2} [symbol] state IN {CA} |
| c₂ | age IN {1, 2} [symbol] state IN {NY} |
| c₃ | age IN {1, 3} |
| c₄ | state IN {CA} |

TABLE 2
Inverted index for Table 1

| Key | Posting List |
|---|---|
| (age, 2) | c₁ → c₂ |
| (age, 1) | c₁ → c₂ → c₃ |
| (state, CA) | c₁ → c₄ |
| (state, NY) | c₂ |
| (age, 3) | c₃ |

### The Counting Algorithm

In an embodiment known as The Counting Algorithm the algorithm is applied on for contract expressions in the form of conjunctions. The idea is to maintain a counter for each contract on how many predicates of the contract are satisfied. The inverted index for the conditions of the impression opportunity is scanned once. This algorithm can be considered as a baseline algorithm for performance comparison. Notice that the Counting Algorithm can support NOT-IN predicates by modifying Step 8 of Algorithm 2, namely by setting the Count value to minus infinity if the contract is tagged NOT-IN.

Algorithm 2: The Counting algorithm

1: input: inverted index idx, set of contracts C, impression I
2: output: set of contracts O matching I
3: O ←Ø
4: Count.init( )
5: P ← idx.GetPostingLists(I) /*Get the posting lists of each (name,
single value) pair of I*/
6: for i=0..(P.size( ) − 1) do /*for all posting lists*/
7: for j=0..(P[i].size( ) − 1) do /*for all contracts within posting
list*/
8: Count[P[i][j]]← Count[P[i][j]]+1
9: end for
10: end for
11: for all c 531 C do
12: if Count[c]= |c| then
13: O ← O ∪{c}
14: end if
15: end for
16: return O

Example: Consider the impression opportunity I={age=1 [symbol] state=CA}. Given the inverted index in Table 2, the posting lists for I are shown in Table 3.

TABLE 3
Posting lists for impression opportunity I

| Key | Posting List |
|---|---|
| (age, 1) | c₁ → c₂ → c₃ |
| (state, CA) | c₁ → c₄ |

Scan through the posting lists and increment the counters for each contract. The final counts are shown in Table 4.

TABLE 4
Final counts for the contracts

| Contract | Count |
|---|---|
| c₁ | 2 |
| c₂ | 1 |
| c₃ | 1 |
| c₄ | 1 |

For each contract in Table 4, compare the count value with the number of predicates in the contract (i.e., the size of the contract). As a result, contracts c₁, c₃, and c₄ are satisfied by I because their counts are equal to their sizes.

Complexity: The complexity of the Counting algorithm is linear to the sum of the posting list sizes of P:

O(Σ_{k=0..|P|-1}|P[k]|)

### The WAND Algorithm

Another embodiment uses a variant of the WAND algorithm [Broder et al.] The WAND algorithm assumes a conjunction of IN predicates for contracts. Compared to the Counting algorithm, WAND makes the following improvements.
1. WAND exploits the conjunctive form structure of the contracts to skip contracts (in the posting lists) that are guaranteed not to match the impression opportunity.
2. WAND partitions contracts according to their sizes (i.e., number of predicates) and processes one partition at a time. In various embodiments, this partitioning is expeditious when using constant thresholds for finding matching contracts, and the size of each contract is the threshold used for matching.

In this algorithm, contracts of size K=0 (i.e., there are no predicates), are deemed to always match. Since contracts of size K=0 do not appear in the posting lists, a separate posting list (called Z) that contains all contracts of size 0 is maintained. When K=0, Z is always returned by the idx.GetPostingLists method.

In our examples, we denote the posting lists for contracts of size K as P_{K}. For example, the posting lists for contracts of size 2 is denoted as P₂.

Algorithm 3 The WAND algorithm

1: input: inverted index idx, set of contracts C, impression I
2: output: set of contracts O matching I
3: O ←Ø
4: MaxSize ←idx.GetMaxContractSize(I)
5: for K =0..MaxSize do
6: P ← idx.GetPostingLists(I,K) /*Get posting lists for all the
contracts that have size K. If K =0, also retrieve Z.*/
7: if K =0 then /*Other than the additional posting list, the
processing of K =0 and K =1 is identical*/
8: K ← 1
9: end if
10: if P.size( )<K then
11: continue to next for loop
12: end if
13: while P[K − 1].Current ≠ null do
14: SortByContractID(P) /*the cost is logarithmic: one bubbling
down per posting list advanced*/
15: if P[0].Current.ID = P[K − 1].Current.ID then
16: O ← O ∪{P[0].Current}
17: NextID ← P[K − 1].Current.ID +1 /*NextID is the smallest
possible ID after current*/
18: else
19: NextID ← P[K − 1].Current.ID
20: end if
21: for L =0..K − 1 do
22: P [L].SkipTo(NextID) /*skip to smallest ID in P[L] such
that ID ≧ NextID*/
23: end for
24: end while
25: end for
26: return O

Example: Algorithm 3 extracts the posting lists of I from idx. This time, however, the algorithm extracts posting lists for each possible size of contracts. In Table 1, there are shown two sizes of contracts: size K=1 contains the set of contracts (c₃, c₄) and size K=2 contains the set of contracts (c₁, c₂). Hence, Table 5 shows two sets of posting lists for each size. The current contract of each posting list is underlined. Notice that in this example, the posting lists are in sorted order according to their contract IDs.

TABLE 5
WAND Posting lists for impression opportunity I

| Size of Contracts | Key | Posting List |
|---|---|---|
| 1 | (age, 1) | c₃ |
| | (state, CA) | c₄ |
| 2 | (state, CA) | c₁ |
| | (age, 1) | c₁ → c₂ |

Processing continues by processing P1, that is, the posting lists of contracts with size 1. Since P₁[0].Current.ID=P₁[0].Current.ID=3 at Step 15, this example adds c₃ to 0 in Step 16. The algorithm then skips all the posting lists to C₄ because P[0].Current.ID +1=3+1=4. Hence, P₁[0] reaches the end of the list while P₁[1] still has c₄ as its current contract. The posting lists after sorting P₁ are shown in Table 6. Notice that the posting list of (age, 1) is placed at the end because it is done with processing. Since P₁[0].Current.ID=P₁[0].Current.ID=4 at Step 15, c₄ is also accepted and included in O. After advancing the posting list P₁[0], the algorithm exits the while loop in Step 13.

TABLE 6
Sorted result of P₂ during first loop

| Key | Posting List |
|---|---|
| (state, CA) | c₄ |
| (age, 1) | c₃ → null |

Next, process P2 in the second for loop. Since K is 2 and P₂[0].Current.ID=P₂[1].Current.ID=1, Step 16 adds c₁ to O. Since NextID is 2, we advance both posting lists in P₂ to c₂. Notice that the posting list with key (state, CA) does not contain c₂ and thus points to null, i.e., the end of the list. The posting lists after sorting P₂ in Step 14 are shown in Table 7. This time, P₂[0].Current=c₂ while P₂[1].Current=null, so go back to Step 13. Since P₂[1].Current=null, terminate the while loop and return O={c₁, c₃, c₄} as our result.

TABLE 7
Sorted result of P₂ during second loop

| Key | Posting List |
|---|---|
| (age, 1) | c₁ → c₂ |
| (state, CA) | c₁ → null |

Complexity: Although WAND improves the Counting algorithm by using skipping and partitioning techniques, its complexity is actually greater than that of the Counting Algorithm. In the worst case, the WAND Algorithm needs to sort the posting list P while advancing one posting list in Step 22. Sorting in Step 14 actually takes logarithmic time to |P| because the inverted index is initially sorted, and we only need to bubble down one posting list in P using a heap to maintain a sorted order for each posting list advanced. Hence, the complexity becomes

O(log(|P|)×Σ_{k=0..|P|-1}P[k]|)

### Supporting NOT-IN Predicates

Two possible extensions of Algorithm 3 to support NOT-IN predicates are here disclosed. A simple method is to split the inverted index into a “positive inverted index,” which contains posting lists for the IN predicates, and a “negative inverted index,” which contains posting lists for the NOT-IN predicates. Although this method supports arbitrary conjunctions with NOT-IN predicates, the number of posting lists for an impression opportunity could be large if many contracts contain different NOT-IN predicates. Thus a method that does not use the negative inverted index is desired. In this latter case (the method of which is disclosed below), the inverted index size is bounded by the size of the impression opportunity, making the method practical for real-time applications.

Using One Inverted Index: Algorithm 3 might be extended to support NOT-IN predicates without using the negative inverted index. The key idea is to prune contracts whose NOT-IN predicates are violated by the impression opportunity. The motivations for the extensions become more evident in the example presented after the discussion of the algorithm.
1. Extension #1: The size of a contract is defined as the number of IN predicates (we ignore NOT-IN predicates) within the expression. For example, a contract with 2 IN predicates and 1 NOT-IN predicates has a size of 2, not 3. Intuitively, all contracts whose IN predicates are satisfied are candidates for being completely satisfied (ignoring the NOT-IN predicates for now). The main reason for this re-definition is to prevent “false negatives” where contracts that are actually satisfied are missed. A contract with no IN predicates has a size of 0.
2. Extension #2: When sorting posting lists in Step 14 of Algorithm 3, assume that c−1<c(NOT-IN)<c<c+1. That is, a posting list with c(NOT-IN) as its current contract is placed before a posting list with c as its current contract. The idea is to reject contracts whose NOT-IN predicate is violated as soon as possible. This sorting order serves to prevent “false positives” where contracts that should be rejected are mistakenly accepted. Notice that the new sorting is not necessary to support NOT-INs and the algorithm instead scans the posting lists that have c as their current contracts until a NOT-IN tag.
3. Extension #3: Instead of simply comparing P[0]. Current and P[K−1]. Current as in Step 15, the algorithm extension now additionally checks (after confirming P[0].Current.ID=P[K−1]. Current.ID) whether P[0].Current is flagged as NOT-IN.

If so, there exists a NOT-IN predicate that is violated, and thus the iteration can immediately reject P[0].Current. Notice the exploitation of the new sorting of Extension #2 to efficiently detect a NOT-IN violation. When a contract is rejected, all the posting lists that have P[0].Current as their current contracts are advanced.
4. Extension #4: As a corner case, it is possible to have “self-contradicting” contracts that contain both the positive and negative version of the same predicate. For example, contract c={age IN {1} [symbol] age NOT-IN {1}} is self-contradicting. Such contracts have the property of appearing in the same posting list exactly twice (e.g., the posting list for (age, 1) contains both c and c(NOT-IN)). In this case, processing can safely remove both contract entries because c will never match any impression opportunity.

Algorithm 6 shows the extended WAND algorithm. The only code change made from Algorithm 3 is the addition of Steps 18-27, which reflect Extension 3. Notice the proper support for contracts of size 0 (i.e., they have no IN predicates) because, if K=0, the algorithm always adds the posting list Z that contains all contracts of size 0. Hence, there is no case where a matching contract is missing from the posting lists.

Algorithm 6: The WAND algorithm supporting NOT-IN predicates

1: input: inverted index idx, set of contracts C, impression I
2: output: set of contracts O matching I
3: O ←Ø
4: MaxSize ←idx.GetMaxContractSize(I) /*Get posting lists of all
(name,value) pairs of I and partition them by contracts of different
sizes like in Table 13*/
5: for K =0..MaxSize do
6: P ← idx.GetPostingLists(I,K) /*Get posting lists for all the
contracts that have size K. If K =0, also retrieve the posting list Z.
*/
7: if K =0 then /*Other than the additional posting list, the
processing of K =0 and K =1 is identical*/
8: K ← 1
9: end if
10: if P.size( ) < K then
11: continue to next for loop
12: end if
13: while P[K − 1].Current ≠ null do
14: SortByContractID(P) /*the cost is O(|P|log(|P|))*/
15: if P [0].Current.ID = P[K − 1].Current.ID then
16:
17: /* NEWLY ADDED CODE START */
18: if P[0].Current.flag =NOT-IN then /*reject contract if a
NOT-IN predicate is violated*/
19: RejectID ← P[0].Current.ID
20: for i = K..(P.size( )− 1) do /*advance all posting lists
with RejectID as their current contracts*/
21: if P[i].Current.ID = RejectID then
22: P[i].SkipTo(RejectID +1)
23: else
24: break out of for loop
25: end if
26: end for
27: continue to next while loop
28: /* NEWLY ADDED CODE END */
29:
30: else /*contract is fully satisfied*/
31: O ← O ∪{P[0].Current}
32: end if
33: NextID ← P[K − 1].Current.ID +1 /*NextID is the
smallest possible ID after current*/
34: else
35: NextID ← P[K − 1].Current.ID
36: end if
37: for L =0..K − 1 do
38: P[L].SkipTo(NextID) /*skip to smallest ID in P[L] such
that ID ≧ NextID*/
39: end for
40: end while
41: end for
42: return O

Example: Note the contracts in Table 11. Notice that c₄ is a self-contradicting contract and cannot be satisfied in any way. Also, c₃ is a contract of size 0.

TABLE 11
A set of contracts

| Contract | Expression |
|---|---|
| c₁ | age IN {1, 2} [symbol] state NOT-IN {CA} |
| c₂ | age IN {1, 2} [symbol] state NOT-IN {NY} |
| c₃ | age NOT-IN {3} [symbol] state NOT-IN {NY} |
| c₄ | age IN {1} [symbol] age NOT-IN {1} |

The inverted index constructed by simulating Algorithm 6 over the set of contracts of Table 11 is shown in Table 12. Notice that c₄, the self-contradicting contract, does not appear in the posting list for (age, 1).

TABLE 12
Inverted index for Table 11

| Key | Posting List |
|---|---|
| (state, CA) | c₁(NOT-IN) |
| (age, 2) | c₁ → c₂ |
| (age, 1) | c₁ → c₂ |
| (state, NY) | c₂(NOT-IN)→ c₃(NOT-IN) |
| (age, 3) | c₃(NOT-IN) |

Given an impression opportunity I={age=1 [symbol] state=CA }, the posting lists for I are shown in Table 13. Notice that c₁, c₂ have now been placed in the group of contracts of size 1 because they only have one IN predicate. Contract c₃ is placed in the posting list Z because it has size=0.

TABLE 13
WAND Posting lists for impression opportunity I with NOT-IN tags

| Size of contracts | Key | Posting List |
|---|---|---|
| 0 | Z | c₃ |
| 1 | (state, CA) | c₁ (NOT-IN) |
| | (age, 1) | c₁ → c₂ |

Continuing, processing P₀ in Algorithm 6. Since P₀[0].Current.ID=P₀[0].Current.ID=3 at Step 15, accept c₃ and add it to O. Now start processing P₁. Since P₁[0].Current.ID=P₁[0].Current.ID=1 at Step 15, but P₁[0].Currentflag=NOT-IN, we reject c₁ by advancing both the posting lists of (state, CA) and (age, 1). After sorting P₁, the intermediate result is shown in Table 14.

TABLE 14
Sorted P1 in second while loop

| Key | Posting List |
|---|---|
| (age, 1) | c₁ → c₂ |
| (state, CA) | c₁(NOT-IN)→ null |

During the next while loop, include c₂ in O because P₁[0].Current.ID=P1[0].Current.ID=2 and P₁[0].Currentflag≠NOT-IN. Then escape the while loop at the next while condition and terminate, returning O={c₂, c₃} as the result.

Complexity: Unlike Algorithm 3, the sorting in Step 14 takes O(|P|log(|P|)) time because of the new sorting we use for contracts with NOT-IN tags. For example, consider the two posting lists (age, 1): c₁→c₂ and (state, CA): c₁→c₃, which are in sorted order of contract IDs. If we do not use any NOT-IN tags, then the two posting lists are still sorted even after advancing them by one contract. However, consider use of NOT-IN tags and have (age, 1): c₁→c₂ and (state, CA): c₁l(NOT-IN)→c₃. Then according to the new sorting, (state, CA) now precedes (age, 1) because c₁(NOT-IN)<c₁. However, this implies a re-sort of the two posting lists once they are advanced because the ordering of c₂ and c₃ is disrupted. Hence Step 14 needs to do an entire sort again. Even skipping the new ordering (i.e., c(NOT-IN)<c), we then need to do a O(|P″) scan in Step 18 instead of a single equality check, making the overall algorithm still have the complexity:

O(|P|log(|P|)×Σ_{k=0..P|-1}|P[k]|)

### Supporting DNF Expressions

The WAND Algorithm can be further extended to support DNF expressions. The idea of Algorithm 7 is to decompose contracts into smaller contracts that have conjunctive expressions and run WAND as if they were separate contracts. After WAND terminates, then return the contracts that have any of their sub-contracts in the output O. Notice that Algorithm 7 can be easily combined with other techniques herein to support DNF expressions containing NOT-IN predicates.

Algorithm 7: The WAND algorithm for DNF expressions

1: input: inverted index idx, set of contracts C, impression I
2: output: set of contracts matching I
3: S ←Ø
4: for all c 531 C do
5: S ← S ∪ GetDisjuncts(c)
6: end for
7: O ← WAND(idx, S, I)
8: return all contracts that have any of their disjuncts in O

Example: Consider the DNF contracts shown in Table 15 and the impression opportunity I={age=1 [symbol] state=CA}.

TABLE 15
A set of contracts

| Contract | Expression |
|---|---|
| c₁ | age IN {1} [symbol] state IN {CA} |
| c₂ | age IN {1} [symbol] (age IN {2} [symbol] state IN {NY}) |
| c₃ | age NOT-IN {1} [symbol] state IN {NY} |

First extract the disjuncts of all contracts and form “sub-contracts” as shown in Table 16.

TABLE 16
A set of contracts

| Contract | Expression |
|---|---|
| c₁¹ | age IN {1} |
| c₁² | state IN {CA} |
| c₂¹ | age IN {1} |
| c₂² | age IN {2} [symbol] state IN {NY} |
| c₃ | age NOT-IN {1} [symbol] state IN {NY} |

After running WAND, we get the satisfying sub-contracts {c¹¹, c₁² , c₂¹}. Thus we return the contracts {c₁, c₂} as the final solution.

### Supporting CNF Expressions

Algorithm 3 can be extended to support CNF expressions. The idea is to use the WAND algorithm on the outer conjunctions of the CNF expressions of contracts. The following extensions from Algorithm 3 are made.
1. Extension #5: Define the size of a contract as the number of conjuncts (instead of disjuncts).
2. Extension #6: A contract c in a posting list now contains an ID of the conjunct that contains the posting list predicate (see Table 18 for an example). For each satisfying contract c that is in at least K=|c| posting lists, additionally check whether |c| different conjuncts of c are satisfied. For example, if c={age=1 [symbol] (gender=M [symbol] state=CA)}, then make sure that the two conjuncts of c are satisfied. If the impression opportunity is I={age=1 [symbol] gender=M}, then c is satisfied. On the other hand, if I={gender=M [symbol] state=CA}, then c is not satisfied because only the second conjunct is satisfied. Notice that more than one conjuncts may contain the same predicate. For example, in c={(age=1 [symbol] state=CA) [symbol] (age=1 [symbol] state=NY)}, the predicate age=1 is contained in both conjuncts of c. In this case, make a separate posting list for each distinct conjunct ID. (If many contracts have multiple conjunct IDs for the same posting list, make duplicates of the posting list as many as the maximum number of distinct conjunct IDs among the contracts.) This operation is needed for the CNF algorithm to do skipping in a WAND fashion as shown in the subsequent examples. The downside of duplicating posting lists, however, is that the sorting cost increases. Alternatively, it is possible to avoid the duplication by defining the size of a contract c as the minimum number of predicates to satisfy c. (The size of c={(age=1 [symbol] state=CA) [symbol] (age=1 [symbol] state=NY)} is then 1.) One embodiment stores several conjunct IDs in the same contract of a posting list. Instead of simple comparing the 1st and Kth posting list, scan all the posting lists that have c as their current contracts and union the conjunct IDs.

The only code change in Algorithm 8 compared to Algorithm 3 is the inclusion of Steps 18-26, which reflects the Extension #6 above.

Algorithm 8: The WAND algorithm for CNF expressions

1: input: inverted index idx, set of contracts C, impression I
2: output: set of contracts O matching I
3: O ←Ø
4: MaxSize ←idx.GetMaxContractSize(I)
5: for K =0..MaxSize do
6: P ← idx.GetPostingLists(I,K) /*Get posting lists for all the
contracts that have size K. If K =0, also retrieve the posting list
Z*/
7: if K =0 then /*Other than the additional posting list, the
processing of K =0 and K =1 is identical*/
8: K ← 1
9: end if
10: if P.size( )< K then
11: continue to next for loop
12: end if
13: while P[K − 1].Current ≠ null do
14: SortByContractID(P) /*the cost is linear: one bubbling down
per posting list advanced*/
15: if P[0].Current.ID = P[K − 1].Current.ID then
16:
17: /* NEWLY ADDED CODE START */
18: ConjunctIDSet ←Ø
19: for 1 =0..(P.size( )− 1) do
20: if P[i].Current.ID = P [0].Current.ID then
21: ConjunctIDSet ← ConjunctIDSet
∪{P[i].Current.ConjunctID}
22: else
23: break out of for loop
24: end if
25: end for
26: if |ConjunctIDSet| = K then /*contract is fully
satisfied*/
27: /* NEWLY ADDED CODE END */
28:
29: O ← O ∪{P[0].Current}
30: end if
31: NextID ← P[K − 1].Current.ID +1 /*NextID is the smallest
possible ID after current*/
32: else
33: NextID ← P[K − 1].Current.ID
34: end if
35: for L =0..K − 1 do
36: P [L].SkipTo(NextID) /*skip to smallest ID in P [L]such
that ID ≧ NextID*/
37: end for
38: end while
39: end for
40: return O

Example: Consider the contracts in Table 17. The inverted index is shown in Table 18. Notice the conjunct ID is placed after each contract, indicating which conjunct of the contract the posting list predicate is located in. For example, posting list predicate (state, CA) is located in the second conjunct of c₁, and thus, add the tag “(2)” to c₁. Also notice that there are two posting lists for (age, 1) because c₃ has two conjunct IDs.

Given an impression opportunity I={age=1 [symbol] gender=F}, the posting lists for I are shown in Table 27.

TABLE 17
A set of contracts

| Contract | Expression |
|---|---|
| c₁ | age IN {1} [symbol] (gender IN {F} [symbol] state IN {CA}) |
| c₂ | (age IN {1} [symbol] gender IN {F}) [symbol] state IN {CA} |
| c₃ | (age IN {1} [symbol] gender IN {F}) [symbol] (age IN {1} [symbol] state IN {CA}) |
| c₄ | (age IN {1, 2} [symbol] ender IN {F}) |

TABLE 18
Inverted index for Table 17

| Key | Posting List |
|---|---|
| (state, CA) | c₁(2)→ c₂(2)→ c₃(3) |
| (age, 1) | c₁(1)→ c₂(1)→ c₃(1)→ c₄(1) |
| (gender, F) | c₁(2)→ c₂(1)→ c₃(1)→ c₄(1) |
| (age, 1) | c₃(2) |
| (age, 2) | c₄(1) |

Processing P₁ in Algorithm 8: Since P₁[0].Current.ID=P₁[0].Current.ID=4 at Step 15, start counting the number of distinct conjuncts for c₄ by scanning the posting lists that have c₄ as their current contracts (hence, consider both posting lists of P₁). Since both posting list predicates (age, 1) and (gender, F) are in the first conjunct, |ConjunctIDSet|={1}|=1=K. Hence, accept c₄ and add it to O. After processing P₁, start processing P₂. Since P₂[0].Current.ID=P₂[1].Current.ID=1 at Step 15, start counting the number of distinct conjuncts for c₁. Since |ConjunctIDSet|=|{1, 2}|=2=K, add c₁ to O. After advancing the two posting lists, the intermediate state of the posting lists of P₂ is shown in Table 20. Since P₂[0].Current.ID=P₂[1].Current.ID=2 at Step 15, start counting the number of distinct conjuncts for c₂. This time, however, |ConjunctIDSet|=|{1}|=1<2=K, so we reject c₂. We advance the two posting lists again, arriving at Table 21. Since |ConjunctIDSet|=|{1}∪{1}∪{2}|=|{1, 2}|=2=K, ad c₃ to O. Hence, return the final result O={c₁, c₃, c₄}.

Supporting CNF Expressions with NOT-IN Predicates

Further embodiments implement two possible extensions to support CNF expression with NOT-IN predicates. As earlier indicated a simple method is to split the inverted index into positive and negative inverted indexes however, an enhanced method described below does not use the negative inverted index. The inverted index size is then bounded by the size of the impression opportunity, making the enhanced method practical for real-time applications. We explain each option in the next sections.

One important intuition to have is that, the more complex the contract expression, the more information is needed in the posting lists and the more operations are needed to perform in order to tell if the contract is really satisfied. To reduce complexity, the extensions are defined to use a minimum of information and expend a minimum of work to evaluate the contract. To reduce runtimes, some simplifications or restrictions (e.g. limiting depth of predicates within a conjunct) are applied.

Using one inverted index: One embodiment of an enhanced algorithm for CNF expressions with NOT-IN predicates uses one inverted index.
1. Extension #8: The size of a contract is the number of conjuncts that do not contain any NOT-IN predicates. For example, the size of c={(age IN {1, 2}) [symbol] (gender IN {M} [symbol] state NOT-IN {CA, NY})} is 1.
2. Extension #9: A contract in a posting list contains the NOT-IN flag, conjunct ID, and the number of NOT-IN predicates in the conjunct. For example, the contract c above in the posting list (state, CA) would contain the information (flag=NOT-IN, ConjID=2, NOTCnt=1).
3. Extension #10: For each candidate contract c that is returned by WAND, create an array of integers where each integer is assigned to a conjunct of c and is used as a counter to determine whether the conjunct is satisfied or not. The counters are all initialized to 0. Also, distinguish the counters between “type 1” conjuncts that only contain IN predicates and “type 2” conjuncts that contain at least one NOT-IN predicate. If a conjunct does not contain any NOT-IN predicates, the counter is simply set to 1 for any IN predicate satisfied. If a conjunct contains n>0 NOT-IN predicates and has a count 0, its counter is set to the quantity (−n−1) and from then on incremented by 1 for each NOT-IN predicate violated or else the counter is set to 1 if any IN predicate is satisfied. A type 1 conjunct is satisfied if the count is positive and not satisfied if the count is 0. A type 2 conjunct is satisfied if the count is 1 (i.e., at least one IN predicate was satisfied), the count is 0 (i.e., no posting list contains the conjunct ID, which means that at least one NOT-IN predicate was satisfied) or the count is less than −1 (i.e., at least one NOT-IN predicate was satisfied) and is not satisfied if the count is −1 (i.e., all NOT-IN predicates were violated while no IN predicate was satisfied).

Algorithm 10 reflects the ideas above. The only code change compared to Algorithm 3 is the inclusion of Steps 18-40, which reflects the Extension #10 above.

Algorithm 10: The WAND algorithm for CNF expressions with
NOT-IN predicates

1: input: inverted index idx, set of contracts C, impression I
2: output: set of contracts O matching I
3: O ←Ø
4: MaxSize ←idx.GetMaxContractSize(I)
5: for K =0..MaxSize do
6: P ← idx.GetPostingLists(I,K) /*Get posting lists for all the
contracts that have size K. If K =0, also retrieve the posting list
Z*/
7: if K =0 then /*Other than the additional posting list, the
processing of K =0 and K =1 is identical*/
8: K ← 1
9: end if
10: if P.size( )< K then
11: continue to next for loop
12: end if
13: while P[K − 1].Current ≠ null do
14: SortByContractID(P)
15: if P[0].Current.ID = P[K − 1].Current.ID then
16:
17: /* NEWLY ADDED CODE START */
18: A ←new CountArray(P[0].Current.size) /*all counters
initialized to 0*/
19: for i =0..(P.size( )− 1) do
20: if P[i].Current.ID = P[0].Current.ID then
21: if A[P[i].Current.ID].isType2 = true [symbol]
A[P[i].Current.ID].Cnt = 0 then /*initialize counter for Type2
conjunct*/
22: A[P[i].Current.ID].Cnt ←−1− P[i].Current.NOTCnt
23: end if
24: if P[i].Current.flag ≠NOT-IN then
25: A[P[i].Current.ID].Cnt ← 1
26: else if A[P[i].Current.ID].Cnt ≠1 then
27: A[P[i].Current.ID].Cnt ← A[P[i].Current.ID].Cnt +1
28: end if
29: else
30: break out of for loop
31: end if
32: end for
33: Satisfied ← true
34: for i =0..|A|− 1 do
35: if ((A[P[i].Current.ID].isType2 = true [symbol] A[P[i].
Current.ID].Cnt = −1) [symbol] (A[P[i].Current.ID].isType2 = false [symbol] A[P[i].
Current.ID].Cnt =0) then
36: Satisfied ← false
37: break out of for loop
38: end if
39: end for
40: if Satisfied = true then
41: /* NEWLY ADDED CODE END */
42:
43: O ← O ∪{P[0].Current}
44: end if
45: NextID ← P[K − 1].Current.ID +1 /*NextID is the
smallest possible ID after current*/
46: else
47: NextID ← P[K − 1].Current.ID
48: end if
49: for L =0..K − 1 do
50: P[L].SkipTo(NextID)/*skip to smallest ID in P[L]such
that ID ≧ NextID*/
51: end for
52: end while
53: end for
54: return O

Example: Consider the contracts in Table 25.

TABLE 25
A set of contracts

| Contract | Expression |
|---|---|
| c₁ | age IN {1} [symbol] (state NOT-IN {CA} [symbol] gender NOT-IN {M}) |

The inverted index is shown in Table 26.

TABLE 26
Inverted index for Table 25

| Key | Posting List |
|---|---|
| (age, 1) | c₁(flag = IN, ConjID = 1, NOTCnt = 0) |
| (state, CA) | c₁(flag = NOT-IN, ConjID = 2, NOTCnt = 2) |
| (gender, M) | c₁(flag = NOT-IN, ConjID = 2, NOTCnt = 2) |

Given an impression opportunity I={age=1 [symbol] gender=M [symbol] state=NY}, the posting lists for I are shown in Table 27.

Processing P₁ in Algorithm 10: Since P₁[0].Current.ID=P₁[0].Current.ID=1 at Step 15, start evaluating c₁ based on the information in the posting lists. Create the array A which contains two counters for the two conjuncts of c₁. Since the first posting list is an IN predicate for c₁, we set A[0].Cnt to 1. Since the second posting list is a NOT-IN predicate, initialize A[1].Cnt to the quantity (−2−1)=−3 and then increment it to −2. Then accept c₁ because A[0].Cnt=1 and A[1].Cnt<−1.

TABLE 27
WAND Posting lists for impression opportunity I
with CNFs with NOT-IN predicates

| Size of | | |
|---|---|---|
| contracts | Key | Posting List |
| 1 | (age, 1) | c₁(flag = IN, ConjID = 1, NOTCnt = 0) |
| | (gender, M) | c₁(flag = NOT-IN, ConjID = 2, NOTCnt = 2) |

Suppose, on the other hand, that I₂={age=1 [symbol] gender=M [symbol] state=CA}. Then the posting lists for I₂ are shown in Table 28. In this case, A[0].Cnt=1 and A[1].Cnt=−1. The algorithm thus rejects c₁ because A[1].Cnt=−1.

TABLE 28
WAND Posting lists for impression opportunity
I₂ with CNFs with NOT-IN predicates

| Size of | | |
|---|---|---|
| contracts | Key | Posting List |
| 1 | (age, 1) | c₁(flag = IN, ConjID = 1, NOTCnt = 0) |
| | (gender, M) | c₁(flag = NOT-IN, ConjID = 2, NOTCnt = 2) |
| | (state, CA) | c₁(flag = NOT-IN, ConjID = 2, NOTCnt = 2) |

Suppose that I3={age=1 [symbol] gender=F [symbol] state=NY}. Then the posting lists for I3 are shown in Table 29. In this case, A[0].Cnt=1 and A[1].Cnt=0. Notice that A[1].Cnt=0 because none of the posting lists contain the second conjunct. Since the second conjunct is type 2, it has at least one NOT-IN predicate satisfied, thus c₁ is accepted.

Finally, suppose that I4={age=2 [symbol] gender=F [symbol] state=NY}. Then there are no posting lists. Since A[0]=0, reject c₁.

TABLE 29
WAND Posting lists for impression opportunity I3
with CNFs with NOT-IN predicates

| Size of contracts | Key | Posting List |
|---|---|---|
| 1 | (age, 1) | c₁(flag = IN, ConjID = 1, NOTCnt = 0) |

Algorithm 10 has now been extended from the original WAND algorithm 3 and now, able to build an inverted index of contracts when the set of contracts contains targets reduced to CNF expressions containing NOT-IN predicates.

### Section IV: Detailed Description of Exemplary Embodiments

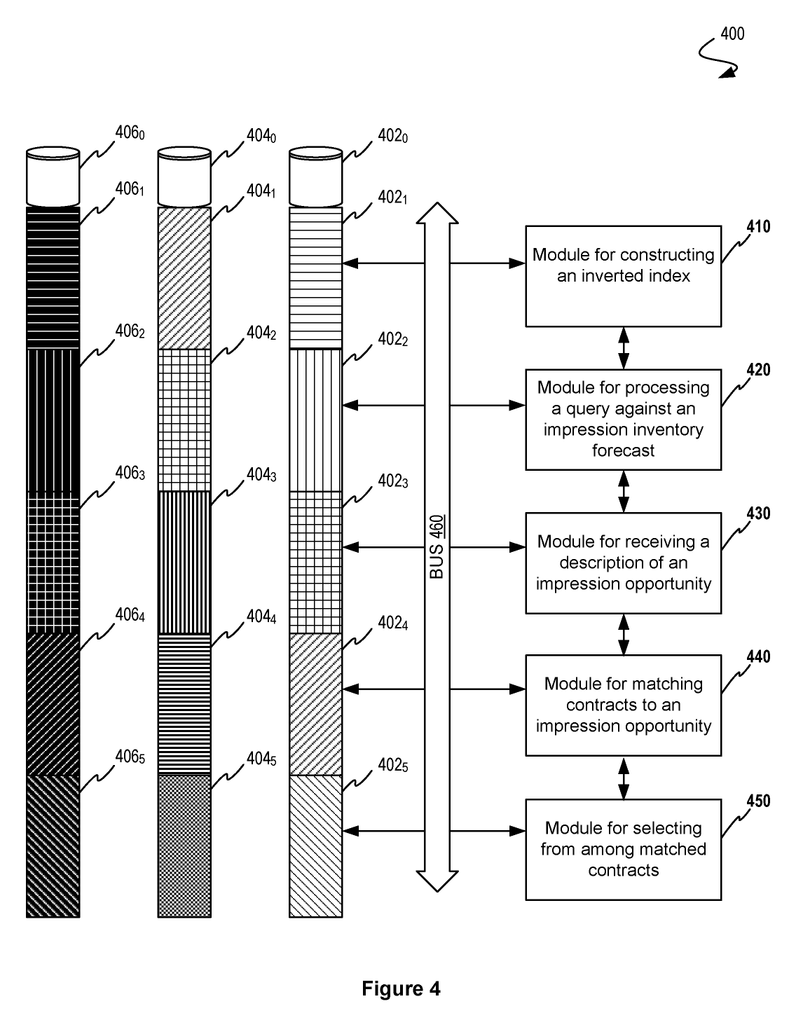

FIG. 4 is a flowchart of a system for automatic matching of contracts to impression opportunities using complex predicates and an inverted index, according to one embodiment. As an option, the present system 400 may be implemented in the context of the architecture and functionality of FIG. 1A through FIG. 3. In particular, system 400 might be included in embodiments of system 300. Of course, however, the system 400 or any operation therein may be carried out in any desired environment. As shown, any of the modules 410, 420, 430, 440, 450 are configured to retrieve & store data from/to one or more databases 402₀, 403₀, 404₀. Moreover, any operation performed by any of the modules 410, 420, 430, 440, 450 might retrieve data in a particular format (e.g. 402₁, 402₂, 402₃, etc), and/or store data during or after any operation into a particular format (e.g. 402₁, 402₂, 402₃, etc). As shown, any of the modules 410, 420, 430, 440, 450 are configured to communicate to or through its neighbors via inter-module signaling, or via changes to a database. In fact, operations within one module might execute before, after, or concurrent with any operations in any other module. In an exemplary practice, the module for constructing an inverted index 410 might conclude its operations at least once before any operations of modules 420, 430, 440, or 450 begin. Once an inverted index is available, operations for matching of contracts to impression opportunities might commence. In somewhat formal terms, and exemplary embodiment might be described as: Module 410 is for constructing an inverted index wherein a first set of contracts are sorted, wherein each contract includes at least one first predicate; module 430 is for receiving an impression opportunity profile, wherein each impression opportunity profile includes at least one second predicate; module 440 is for creating a match set containing any number of contracts from among the first set of contracts, wherein a match operation includes matching at least one first predicate to at least one second predicate; and module 450 is for presenting the match set for delivery of at least one impression.

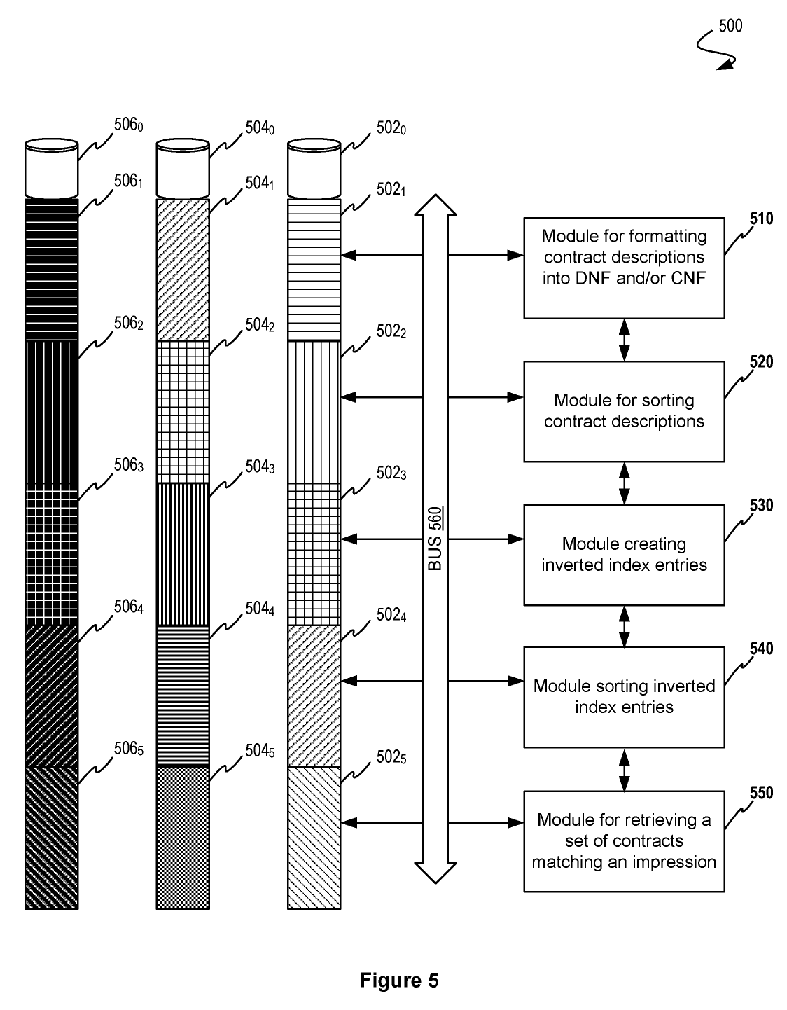

FIG. 5 is a flowchart of a system for automatic matching of contracts to impression opportunities using complex predicates and an inverted index, according to one embodiment. As an option, the present system 500 may be implemented in the context of the architecture and functionality of FIG. 1A through FIG. 4. In particular, system 500 might be included in embodiments of modules 410, 420, 430, 440, or 450. Of course, however, the system 500 or any operation therein may be carried out in any desired environment. Any of the modules 510, 520, 530, 540, 550 may communicate with other modules or with the databases as described above pertaining to FIG. 4, and further may communicate freely to any supervisor or any subordinate system. In somewhat formal terms, an exemplary embodiment might be described as: Module 510 is for formatting contract descriptions into either disjunctive normal form representation, or conjunctive normal form representation; module 520 is for sorting the first set of contracts including sorting by at least one of, a contract ID, or a number of predicates in each contract; module 530 is for creating a plurality of inverted index entries wherein each inverted index entry includes a posting list in sorted order; module 540 is for sorting at least two inverted index entries (e.g. sorting a contract size sorting key, sorting by a predicate sorting key, etc), and module 550 is for retrieving a set of contracts matching an impression opportunity profile. Of course any of the data structures created or modified by system 500 may use any, or all or none of the techniques described in the foregoing.

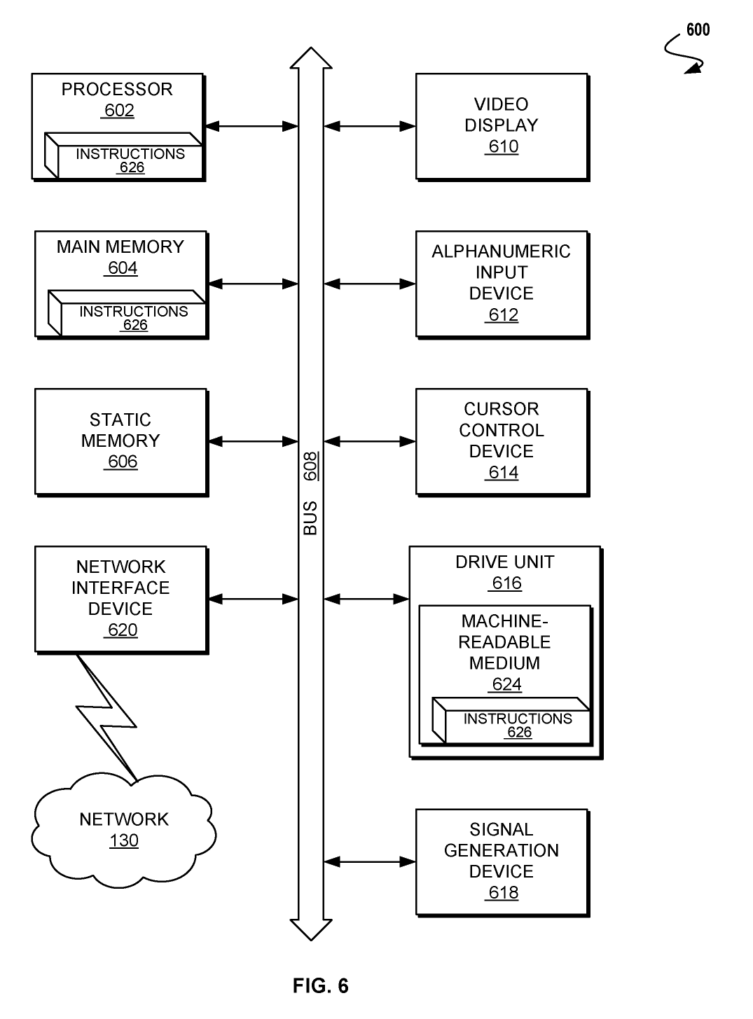

FIG. 6 shows a diagrammatic representation of a machine in the exemplary form of a computer system 600 within which a set of instructions, for causing the machine to perform any one of the methodologies discussed above, may be executed. The embodiment shown is purely exemplary, and might be implemented in the context of one or more of FIG. 1A through FIG. 5. In alternative embodiments, the machine may comprise a network router, a network switch, a network bridge, a Personal Digital Assistant (PDA), a cellular telephone, a web appliance or any machine capable of executing a sequence of instructions that specify actions to be taken by that machine.

The computer system 600 includes a processor 602, a main memory 604 and a static memory 606, which communicate with each other via a bus 608. The computer system 600 may further include a video display unit 610 (e.g. a liquid crystal display (LCD) or a cathode ray tube (CRT)). The computer system 600 also includes an alphanumeric input device 612 (e.g. a keyboard), a cursor control device 614 (e.g. a mouse), a disk drive unit 616, a signal generation device 618 (e.g. a speaker), and a network interface device 620.

The disk drive unit 616 includes a machine-readable medium 624 on which is stored a set of instructions (i.e., software) 626 embodying any one, or all, of the methodologies described above. The software 626 is also shown to reside, completely or at least partially, within the main memory 604 and/or within the processor 602. The software 626 may further be transmitted or received via the network interface device 620 over the network 130.

It is to be understood that embodiments of this invention may be used as, or to support, software programs executed upon some form of processing core (such as the CPU of a computer) or otherwise implemented or realized upon or within a machine or computer readable medium. A machine readable medium includes any mechanism for storing or transmitting information in a form readable by a machine (e.g. a computer). For example, a machine readable medium includes read-only memory (ROM); random access memory (RAM); magnetic disk storage media; optical storage media; flash memory devices; electrical, optical, acoustical or other form of propagated signals (e.g. carrier waves, infrared signals, digital signals, etc.); or any other type of media suitable for storing or transmitting information.

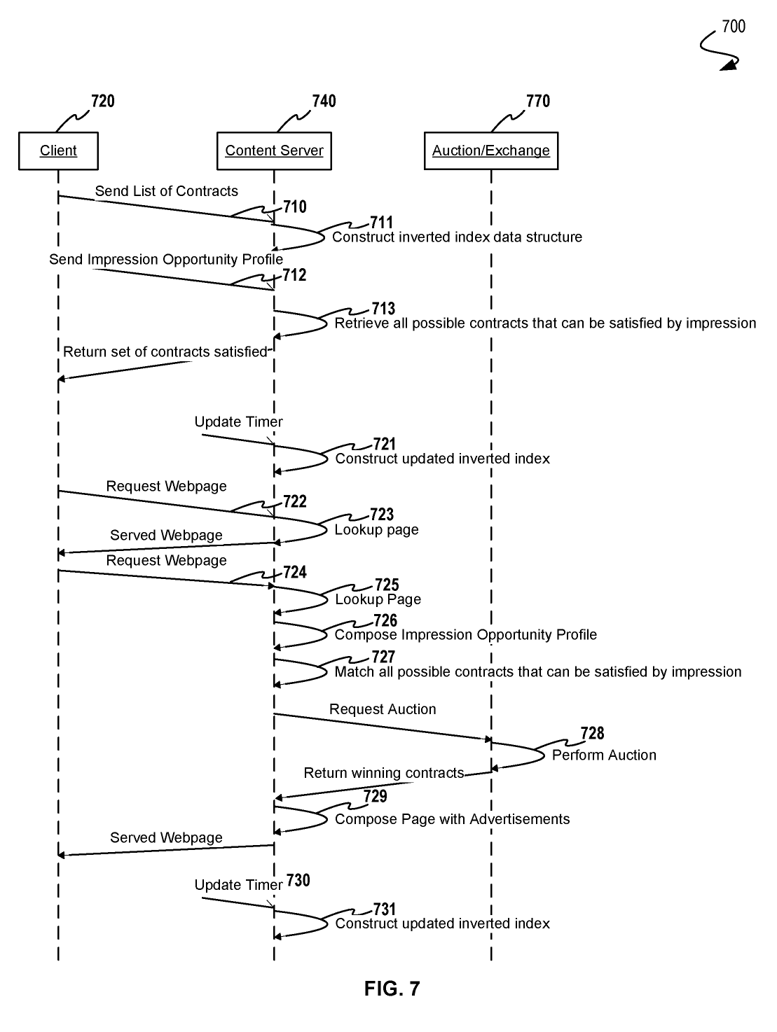

FIG. 7 is a diagrammatic representation of several computer systems (i.e. client, content server, auction/exchange server) in the exemplary form of a client server network 700 within which environment a communication protocol may be executed. The embodiment shown is purely exemplary, and might be implemented in the context of one or more of FIG. 1A through FIG. 6. As shown the content server 740 is operable for receiving a set of contracts 710, each contract containing at least one target predicate in CNF form having a plurality of conjuncts, or in DNF form having a plurality of terms, or in the form of an arbitrarily complex Boolean expression with any number of conjuncts and/or disjuncts; preparing a data structure index of the set of contracts 711, receiving at least one web page profile predicate 712, and retrieving from the data structure contracts wherein at least one target predicate matches at least one web page description predicate 713. Additionally, and as shown in this embodiment, the content server 740 is capable of autonomously and asynchronously constructing an inverted index (see operations 721, 730, and 731). The client 720 is capable of initiating a communication protocol by requesting a web page lookup 722. Such a request might be satisfied solely by a content server 740 by the lookup page operation 723, or it might be satisfied by a content server 740 and any number of additional content servers or advertising servers 770 acting in concert. In general, and as shown in the exemplary embodiment, any server or client for that matter might be capable of performing any or all of the operation 410 through 450, and/or sending data to any database 402₀, 404₀, 406₀, etc which might be located on any server. Strictly for illustrative purposes, any server or client might be configured to perform any one or more operations involved in a method for automatic matching of contracts to impression opportunities using complex predicates and an inverted index. The operations might start from a client requesting a web page 724, and proceed with operations corresponding to a page lookup 725, composing an impression opportunity profile 726, matching contracts to the impression opportunity profile 727, requesting and performing an auction 728, composing the impression including advertisements corresponding to the winning bids 729 and serving the composited page as a web page impression rendered at the client terminal 720.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A method for indexing advertising contracts for matching to a web page profile comprising:
receiving a set of contracts, each contract containing at least one of, a target predicate in CNF form having a plurality of conjuncts, a target predicate in DNF form having a plurality of terms;
preparing a data structure index of the set of contracts;
receiving at least one said web page profile predicate; and
retrieving from the data structure zero or more contracts wherein at least one target predicate matches at least one said web page profile predicate.

2. The method of claim 1, further comprising:
constructing an inverted index wherein a first set of contracts are sorted, wherein each contract includes at least one first predicate;
receiving an impression opportunity profile, wherein each impression opportunity profile includes at least one second predicate;
creating a match set containing any number of contracts from among the first set of contracts, wherein a match operation includes matching at least one first predicate to at least one second predicate; and
presenting the match set for delivery of at least one impression.

3. The method of claim 2, wherein the constructing includes making posting lists of contracts for each IN predicate.

4. The method of claim 3, wherein the posting lists are sorted by a contract id.

5. The method of claim 3, wherein the posting lists include at least one attribute name and single value pair of an IN predicate.

6. The method of claim 2, wherein the contract includes a description containing at least one of, disjunctive normal form representation, conjunctive normal form representation.

7. The method of claim 2, wherein the at least one first predicate is decomposed from a multiple-predicate conjunctive expression.

8. The method of claim 7, wherein the multiple-predicate conjunctive expression includes at least one NOT-IN predicate.

9. The method of claim 2, wherein the at least one first predicate is decomposed from a multiple-predicate disjunctive expression.

10. The method of claim 2, wherein the at least one first predicate includes at least one IN predicate expression.

11. The method of claim 2, wherein the at least one first predicate includes at least one NOT-IN predicate expression.

12. The method of claim 2, wherein the impression opportunity profile is specified as a vector of feature-value pairs.

13. The method of claim 2, wherein the impression opportunity profile includes a description containing at least one of, disjunctive normal form representation, conjunctive normal form representation.

14. The method of claim 2, wherein the match operation skips the contracts that are guaranteed not to match the impression opportunity profile.

15. The method of claim 2, wherein the match operation partitions contracts according to their sizes.

16. The method of claim 2, wherein the match operation prunes contracts containing any NOT-IN predicates violated by the impression opportunity profile.

17. The method of claim 2, wherein constructing further comprises:
formatting contract descriptions into at least one of disjunctive normal form representation, conjunctive normal form representation;
sorting the first set of contracts includes sorting by at least one of, contract ID, number of predicates in each contract;
creating a plurality of inverted index entries wherein each inverted index entry includes a posting list in sorted order;
sorting at least two inverted index entries.

18. The method of claim 17, wherein sorting at least two inverted index entries includes sorting by at least a contract size sorting key and a predicate sorting key.

19. The method of claim 17, wherein creating a plurality of inverted index entries includes duplicates of the posting list as many as the maximum number of distinct conjunct IDs among the first set of contracts

20. An apparatus for indexing advertising contracts for matching to a web page profile comprising:
a module for receiving a set of contracts, each contract containing at least one of, a target predicate in CNF form having a plurality of conjuncts, a target predicate in DNF form having a plurality of terms;
a module for preparing a data structure index of the set of contracts;
a module for receiving at least one said web page profile predicate; and
a module for retrieving from the data structure zero or more contracts wherein at least one target predicate matches at least one said web page profile predicate.
